(19) United States
(12) Patent Application Publication
(10) Pub. No.: US 2002/0110360 A1
(43) Pub. Date: Aug. 15, 2002

(54) Systems and methods for recording fragmented programs

(76) Inventor: Peter J. Potrebic, Mountain View, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/781,110

(22) Filed: Feb. 9, 2001

(51) Int. Cl. H04N 5/91

(52) U.S. Cl. 386/83; 348/906

(57) ABSTRACT

Systems and methods for identifying fragments of one or more programs that are related and are scheduled to be aired at discrete times, and for automatically and sequentially recording each of the fragments so that a collection of the fragments is made available to the viewer. The fragments are preferably identified through the used of electronic program guide data. A recording system automatically records each fragment as it airs to provide the viewer with a collection of fragments.

### BACKGROUND OF THE INVENTION

1. The Field of the Invention

The present invention relates to systems and methods for recording fragmented programs. More specifically, the present invention is directed to systems and methods for identifying fragments of one or more programs that are related and are scheduled to be aired at discrete times, and for sequentially recording each of the fragments, without viewer intervention, so that a collection of the fragments is made available to the viewer.

2. The Prior State of the Art

Home entertainment systems are able to receive a variety of different channels from various sources at any time of the day or night. The channels carry public, cable or satellite television programming. When a program is aired at an inconvenient time, a viewer usually programs a videocassette recorder (“VCR”), a digital video recorder (“DVR”), or another recording system of the home entertainment system to record the program. Once recorded, the viewer can play the recorded version of the program at a more convenient time.

Frequently, programming received by a home entertainment system includes a program that is divided into a series of airings that are broadcast on non-regular or non-repeating intervals. Examples of such a program include mini-series, multi-day sporting events, and some sitcoms. If a viewer desires to record the series of airings of such mini-series, multi-day sporting events, or sitcoms, current methods include requiring the viewer to review the program schedule, identify the separate airings of the series, and separately program the recording system to record each airing of the program.

Alternative methods allow a viewer to program a recording system to record a regularly repeating (i.e. every Tuesday from 8:00 p.m. to 8:30 p.m.) time slot. However, current methods only record a program if the program is aired at the specified time slot. As such, current recording systems do not always record the desired programming. Furthermore, while current recording systems can be programmed to automatically record programming aired at regularly repeating time slots, conventional systems have not been capable of recording groups of related programs, which can also be designated “fragmented programs.” The inability of conventional systems to automatically record, for example, all games in the World Series, or all episodes of a mini-series, has frequently resulted in viewers having to personally identify each airing of the series while programming their systems or to simply not be able to record the series of programs.

### SUMMARY OF THE INVENTION

The present invention relates to systems and methods for recording fragmented programs. More specifically, the present invention is directed to systems and methods for identifying fragments of one or more programs that are related and are scheduled to be aired at discrete times, and for sequentially recording each of the fragments, without viewer intervention, so that a collection of the fragments is made available to the viewer. In this manner, the viewer is required simply to identify the fragmented program (e.g. an irregularly scheduled series), without having to personally identify the date and time of each airing.

Implementation of the present invention includes recording specific airings of programs in ways other than simply recording the same channel at the same time of day in an ongoing, regularly repeating manner. Thus, information from an electronic program guide is utilized to identify when each fragment of a fragmented program will air and to determine the relationship between programs.

A fragmented program is a program that has multiple airings broadcast over multiple days. Each airing is generally referred to as a fragment. Examples of a fragmented program include a mini-series, an ongoing sporting event, etc. A mini-series has a series of airings or fragments that are broadcast on consecutive days. Similarly, an ongoing sporting event is a multi-day event, such as the Olympics, the World Series, The Masters, or some other multi-day tournament that is broadcast over a series of days and the fragments may be broadcast on different networks. An ongoing television program includes a series of episodes that are aired on a regular basis. For purposes of this invention, ongoing television programs are of interest particularly when only some, but not all, of the individual airings are to be recorded.

Each fragment of a fragmented program is identified through the use of information from an electronic program guide and the recording system is automatically programmed to record each fragment as it airs. For example, a unique identifier assigned to a fragmented program can be used to identify each of the fragments of the program. As such, a television network may designate a group of different sitcoms (e.g. a set broadcast during a single evening) as being related for purposes of recording, causing the group of sitcoms to be collectively designated as a fragmented program so as to be automatically recorded without requiring the viewer to select each sitcom included in the group.

Depending on the nature of the programs and user preferences, each fragment of a fragmented program can be recorded in proper order to provide the viewer with a complete version of the fragmented program in the order that it originally aired. Alternatively, the recording system can automatically differentiate between first-run and re-run episodes of an ongoing television program (e.g. a sitcom) and record each new episode of the program throughout a television season, while automatically refraining from recording re-runs of episodes already recorded, thereby providing a viewer with a collection of all of the new episodes of the program at the end of the season. This represents an example of how ongoing programs can be recorded in ways other than simply recording the same channel at the same time of day in a regularly repeating manner.

Implementation of the invention to utilize information from an electronic program guide to identify when each fragment of a fragmented program will air and to determine the relationship between programs eliminates the need of a viewer to personally identify the date and time of the airing of each fragment. Instead, the viewer simply identifies the fragmented program that he/she desires the system to record, and then the system automatically identifies when and on which channel each of the fragments will air, and automatically records each fragment as it airs. Furthermore, if a particular episode airs more than once then the system has multiple opportunities to record the particular episode of the fragmented program. As such, the recording of programs is optimized by avoiding conflicts that occur when multiple programs that are to be recorded air at the same time.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a flowchart that illustrates an exemplary embodiment of the present invention that identifies a fragmented program and determines which fragments to record;

FIG. 3 illustrates an exemplary recording list that is stored at a management system and lists the fragmented programs that are to be recorded;

FIG. 4 illustrates a portion of an exemplary electronic programming guide that relates to Monday programming and may be used in association with a home entertainment system;

FIG. 5 illustrates a portion of an exemplary electronic programming guide that relates to Tuesday programming and may be used in association with a home entertainment system;

FIG. 6 illustrates a portion of an exemplary electronic programming guide that relates to Wednesday programming and may be used in association with an entertainment system;

FIG. 7 illustrates a portion of an exemplary electronic programming guide that relates to Thursday programming and may be used in association with an entertainment system;

FIG. 8 illustrates a portion of an exemplary electronic programming guide that relates to Friday programming and may be used in association with an entertainment system;

FIG. 9 is a flowchart that illustrates an exemplary embodiment for removing a program from a recording list once all fragments of the program have aired and for reminding a viewer of the reoccurrence of a fragmented program; and

FIG. 10 illustrates a recording list that removes fragmented programs once all fragments have been aired, as identified in the exemplary embodiment of FIG. 9.

### DETAILED DESCRIPTION OF THE INVENTION

The present invention relates to systems and methods for recording fragmented programs. More specifically, the present invention is directed to systems and methods for identifying fragments of one or more programs that are related and are scheduled to be aired at discrete times, and for sequentially recording each of the fragments, without viewer intervention, so that a collection of the fragments is made available to the viewer.

Throughout the following disclosure, reference is made to the recording of one or more fragmented programs. In the disclosure and in the claims the term “fragmented program” refers to a program that is divided into a series of airings or a plurality of programs that are related in some way to each other or may be associated with each other. Furthermore, in the disclosure and in the claims the term “fragment” refers to one or more of the series of airings of a fragmented program. In one embodiment, a fragment refers to an episode, which corresponds to a fragmented program that is scheduled to air for an entire season, wherein at least two fragments of the series are temporally separated from each other, as will be further explained below. In another embodiment, a fragment refers to one of a plurality of broadcasts of a particular event.

The embodiments of the present invention may comprise a special purpose or general purpose computer including various computer hardware, as discussed in greater detail below. Set top boxes that enhance the capabilities of conventional televisions represent an example of a special purpose computer. The embodiments may further comprise multiple computers linked in a networked environment.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, such a connection is also properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention will be described in the general context of computer-executable instructions, such as program modules, being executed by set-top boxes or other computers. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The following disclosure of the present invention is grouped into two subheadings, namely “Exemplary Operating Environment” and “Recording Fragmented Programs.” The disclosure relating to the first subheading provides an example of a suitable environment for implementation of the present invention, while the disclosure corresponding to the second subheading provides examples of implementing the present invention. The utilization of the subheadings is for convenience of the reader only and is not to be construed as limiting in any sense.

Exemplary Operating Environment

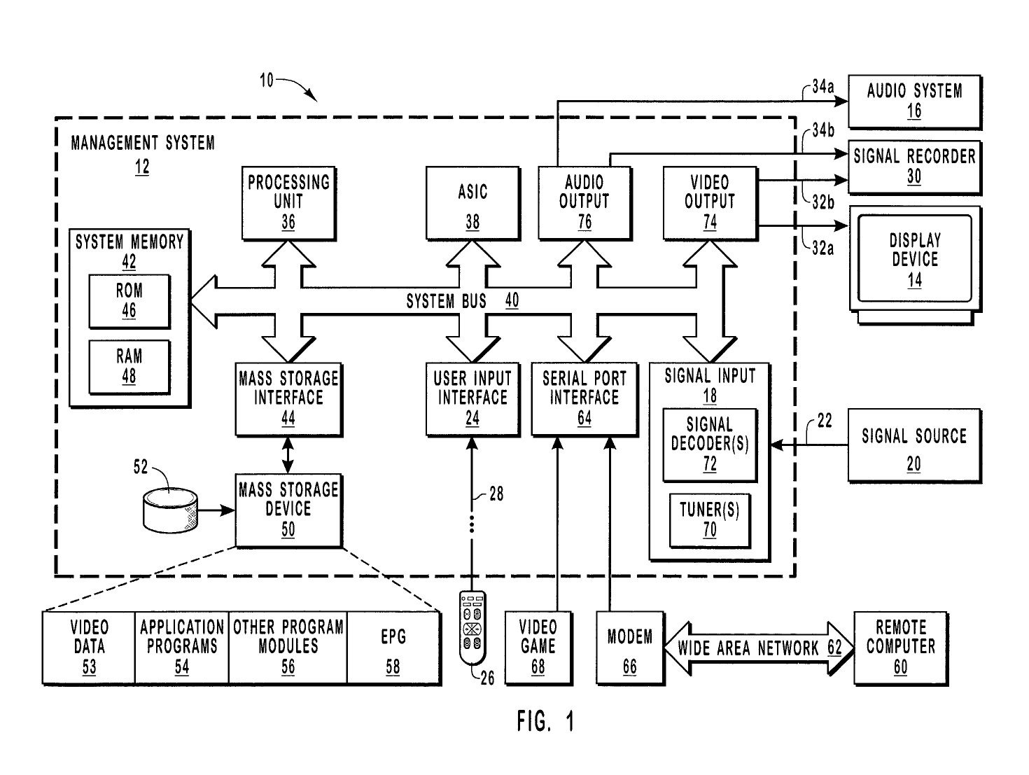

FIG. 1 and the corresponding discussion are intended to provide a general description of a suitable environment in which the invention may be implemented. In the discussion, reference is made to a home entertainment system that may be used for displaying and/or recording programming. For purposes of this description and in the claims, a “home entertainment system” may be a display unit, such as a television screen, coupled to a processing device for performing the data processing steps disclosed herein, or may include any number of interconnected consumer electronic devices, one of which having a processing device for performing the data processing steps disclosed herein. Examples of such consumer electronic devices include a video cassette recorder (“VCR”), a video game system, a stereo system, a television or monitor with data processing capabilities, a cable television box, a digital satellite system receiver (“DSS”), a digital video broadcasting system (“DVB”), a digital versatile disc system (“DVD”), a set-top box that serves as an Internet terminal, and any other device capable of processing data as described herein. Furthermore, the term “home entertainment system” is to be understood as a term that broadly describes a television-viewing environment, whether it is located in a viewer's home, at a place of business, in the public, or at any other location. Also for purposes of this description and in the claims, the term “programming” includes both the viewable portions of moving image data and its associated sound data.

In one embodiment, the present invention is implemented in a system that uses a conventional television screen or other display unit to display information and includes a WebTV® set-top box or a similar Internet terminal that has been adapted to perform the operations that include composing, sending and receiving email, browsing the World Wide Web (“Web”), accessing other segments of the Internet, and otherwise displaying information. An Internet terminal typically uses standard telephone lines, Integrated Services Digital Network (ISDN) lines, cable lines associated with cable television service, or the like to connect to the Internet or other wide area networks.

FIG. 1 illustrates a home entertainment system 10 that includes a management system 12, a display device 14 and an audio system 16. Management system 14 may be a set-top box or Internet terminal that has been adapted to perform the operations disclosed herein. Management system 12 may be integrally positioned with or separate from display device 14, which may be a high definition television display, a standard television display, a flat panel display, a projection device, a high definition television display, a computer monitor, or any other device capable of displaying viewable video image data. Audio system 16 may be a speaker, a stereo system, or any device capable of emitting sound data, and similarly may be integrally positioned with or separate from display device 14.

Management system 12 includes a signal input 18, which receives programming from a signal source 20. The programming is transmitted from signal source 20 to signal input 18 via a programming input line 22, which can be a cable or optic connection, a terrestrial antenna system, a satellite system, or any device or system capable of transmitting programming to home management system 12.

The signal source 20 may be either a single channel signal source or a multiple channel signal source. A single channel signal source provides programming from a recorded medium, such as a videocassette, compact disc, etc. Examples of a single channel signal source include a VCR, a DVD, and the like. Alternatively, a multiple channel signal source includes any system or device that is capable of sending a signal that may be received by a satellite receiver, a cable or optic connection, a terrestrial antenna, or the like. Examples of a multiple channel signal source include DSS/DVB, a cable box, locally broadcast programming (i.e. programming broadcast using UHF or VHF), and the like.

While FIG. 1 illustrates home entertainment system 10 as having a single programming input line 22 and a single signal source 20, there can instead be a plurality of programming input lines that transmit programming from a plurality of signal sources. In such embodiments, the home entertainment system may receive the programming from one signal source or from a plurality of signal sources at a time.

Management system 12 also includes a user input interface 24, which receives input from an input device 26, such as a remote control, keyboard, microphone, or any other device capable of generating electronic instructions for management system 12. Input device 26 is communicatively coupled to management system 12 over an input link 28 so as to enable such control. Input device 26 generates electronic instructions over input link 28 in response to preprogrammed data or in response to a viewer pressing buttons on input device 26. Input device 26 may also control Web browser software within management system 12 as when management system 12 is a set-top box or an Internet terminal that has been adapted to perform the operations disclosed herein. For instance, input device 26 may be programmed to turn on home entertainment system 10 and to tune management system 12 to a channel.

FIG. 1 illustrates a signal recorder 30, which is capable of receiving video and/or audio data and recording the data on a storage medium. Video signals are transmitted to signal recorder 30 and/or display device 14 by video image link 32, examples of which include a radio-frequency (“RF”) link, an S-video link, a composite link, or any other equivalent form of video image link. Similarly, audio link 34 transmits audio data from management system 12 to audio system 16 or to signal recorder 30.

The operation of management system 12 is controlled by a central processing unit (“CPU”), illustrated as processing unit 36, which is coupled to an application-specific integrated circuit (“ASIC”) 38 and uses computer-executable instructions implemented in software and/or hardwired logic circuitry. Processing unit 36 and ASIC 38 are coupled via a system bus 40, which also interconnects various other system components, such as the system memory 42, mass storage interface 44, user interface 24 and signal input 18. Processing unit 36 executes software designed to implement features of management system 12 including features of the present invention. ASIC 38 contains circuitry that is used to implement certain functions of management system 12. Instructions, data, and other software necessary for the operation of processing unit 36 and ASIC 38 may be stored in the system memory 42, such as in read-only memory (“ROM”) 46 and/or in random-access memory (“RAM”) 48, and/or in a mass storage device 50, which is coupled to mass storage interface 44. ROM 46, RAM 48 and mass storage device 50 are communicatively coupled to ASIC 38 so as to be readable by ASIC 38 and so that data may be written from ASIC 38 to RAM 48 and possibly mass storage device 50.

Mass storage device 50 may be a magnetic hard disk 52 or any other magnetic or optical mass memory device that is capable of storing large amounts of data. Any desired computer-readable instructions or data, including application programs 54, other program modules 56, and an electronic programming guide (“EPG”) 58, which specifies the broadcast times and channels of programs can be stored in mass storage device 50. Mass storage device 50 can also be used to record video data 53, in which case, management system 12 generates as a digital video recorder.

EPG data may be obtained in a variety of manners. For instance, the EPG data can be supplied to management system 12 by a remote computer 60, such as a server, and stored on mass storage device 50. The EPG data is supplied on a regular basis to continually maintain a current schedule of programming at the management system 12. Where home entertainment system 12 is associated with the Internet, the data included in the EPG may be downloaded from the Internet. Alternatively, the EPG may delivered to the home entertainment system by using a direct-dial communication over standard telephone lines, or by using data transmission over the cable television infrastructure, a satellite network, an over-the-air broadcasting or any other available medium.

In the embodiment where management system 12 is associated with the Internet, management system 12 communicates with a remote computer 60 via a wide area network (“WAN”) 62 by including a serial port interface 64 that is interposed between the system bus 40 and a modem 66, a wireless link, or other means for establishing communications over a WAN that may be internal or external to management system 12. Management device 12 is also capable of transmitting information via the Internet by direct-dial communication over standard telephone lines, or by using any other available communication medium.

While serial port interface 64 may be utilized to connect a modem 66 for communicating across a WAN, serial port interface may also be utilized to connect other consumer electronic devices, such as video game 68, and/or various input devices, such as a keyboard (not shown) or joystick (not shown), to management device 12.

Referring now to signal input 18, if the signal on programming input line 22 includes multiple channels, a tuner 70 included in signal input 18 tunes to a selected channel in the signal. Multiple tuners 70 can be used to provide enhanced viewing features, such as picture, recording one channel while viewing another, and recording a plurality of channels simultaneously. A signal decoder 72 converts video data from an analog format to a digital format, or from a digital format to an analog format, in the event that ASIC 38 and tuner 70 employ different formats. Video decoder 72 also decodes video data from a compressed video format (e.g. MPEG). In embodiments where the management system 12 includes multiple tuners 70, management system 12 may also include multiple signal decoders 72 to perform the operations disclosed herein.

Management system 12 also includes a video output 74, which may include a video encoder and/or a video converter. The video encoder assigns a code to frames of video data that are transmitted across a video image link 32 and switches between analog and digital formats as necessary. Similarly, audio output 76 can include an audio converter to provide the necessary switching between analog and digital formats.

While FIG. 1 and the corresponding discussion above provide a general description of a suitable environment in which the invention may be implemented, it will be appreciated that the features of the present invention disclosed herein may be practiced in association with a variety of different system configurations.

Recording Fragmented Programs

As provided above, the present invention relates to systems and methods for recording fragmented programs. More specifically, the present invention is directed to systems and methods for identifying fragments of one or more programs that are related and are scheduled to be aired at discrete times, and for sequentially recording each of the fragments, without viewer intervention, so that a collection of the fragments is made available to the viewer.

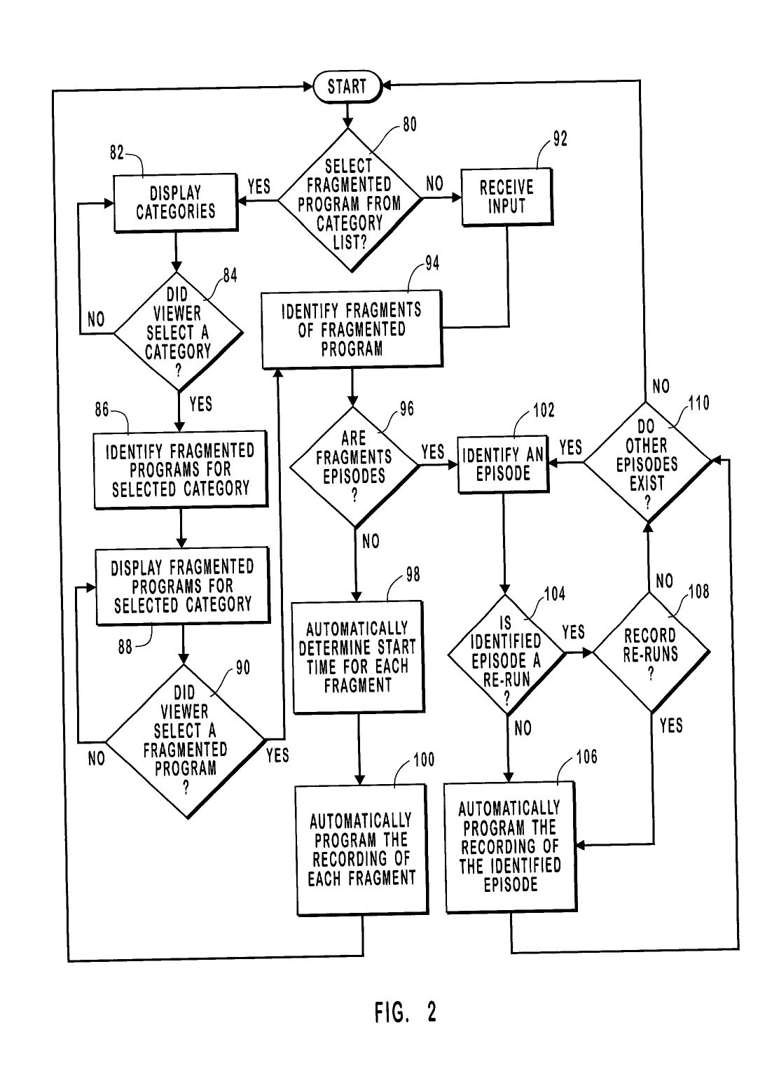

With reference to FIG. 2, an embodiment of the present invention is illustrated in which a fragmented program is identified and a determination is made as to which fragments to record. A fragmented program may be directly identified by a viewer or may be identified upon selecting a fragmented program from a listing of categories. Once identified, the desired fragments of the program are recorded, as will be further explained below.

In the embodiment illustrated in FIG. 2, execution begins at decision block 80 for a determination as to whether or not a fragmented program is selected from a category list, which is a listing of various types of fragmented programs. Examples of categories of fragmented programs include sporting events, mini-series, sitcoms, news broadcasts, and the like. The category list is displayed on a display device of a home entertainment system, such as display device 14 of FIG. 1. A user may provide input to select a category and then to select a fragmented program under the selected category, or may directly identify a fragmented program to record.

Therefore, if at decision block 80 it is determined that a category list will be used to select a fragmented program, execution proceeds to step 82 for the display of the various categories. As provided above, examples of categories of fragmented programs include sporting events, mini-series, sitcoms, news broadcasts, and the like. A menu system is used to display the categories on a display device and to interface with the viewer. A viewer may select a category by providing input through the use of an input device, such as input device 26 in FIG. 1.

At decision block 84 a determination is made as to whether or not a viewer has selected one of the displayed categories. If a viewer has not selected a displayed category, execution returns back to step 82 until a displayed category is selected.

Once a category is selected, execution proceeds to step 86 for the identification of the fragmented programs that can be grouped under the selected category and will be aired on a channel during a specific period of time. The recording system uses electronic program guide data that provides information to identify the airings of the fragmented programs to record. For instance, the title of a program (e.g. “Olympics”) can be used to determine that fragments are related one to another. In other instances, conventional electronic program guide information is enhanced or supplemented by information that specifies that programs are related. One example of this technique is a television network designating a group of sitcoms as being related for purposes of recording. Therefore, the group of sitcoms can be automatically recorded without requiring the viewer to individually select each sitcom included in the group.

In one embodiment, EPG data is enhanced by including a unique identifier that is specific to a fragmented program and is common to each fragment within the particular fragmented program to facilitate the identification of fragmented programs. In another embodiment, EPG data, such as the title of each program, is utilized to identify the fragmented programs. Once identified, step 88 displays on the display device the title of each fragmented program that is scheduled to air during the specific period of time to allow the viewer to select one or more of the programs to record.

Therefore, by way of example, if the category selected by the viewer is entitled “mini-series,” the system searches EPG data to identify all mini-series that are scheduled to air on any channel received by the home entertainment system during a specific period of time. Once identified, the title of each mini-series that will air during the specific period of time is displayed on the display device to allow a viewer to determiner whether or not to record any of the displayed fragmented programs.

Once the fragmented programs of the selected category have been displayed, execution proceeds to decision block 90 for a determination as to whether or not a viewer has selected one of the displayed fragmented programs for recording. If a viewer has not selected one of the displayed fragmented programs, execution returns back to step 88 to wait for viewer input. Once a viewer has selected one of the displayed fragmented programs, execution proceeds to step 94 for the identification of each of the various fragments of the fragmented program, as will be further explained below.

Returning back to decision block 80, if it is determined that a category list will not be used to select a fragmented program, execution proceeds to step 92 to receive viewer input regarding the fragmented program that the viewer desires to have recorded. As provided above, a viewer may directly select a fragmented program to record by inputting information to the home entertainment system, such as the title of the program or by selecting a single fragment included in the fragmented program from a user interface associated with an electronic program guide.

Once a fragmented program has been selected by a viewer to be recorded, execution proceeds to step 94 for an identification of each of the various fragments of the fragmented program. A program may be fragmented in a variety of ways. For example, the program may be a mini-series that is aired at a specific time during consecutive days of a week. Alternatively, a fragmented program may be a sporting event that takes place over a plurality of days, such as the Major League Baseball World Series (“World Series”), the National Basketball Association (“NBA”) Finals, a golf tournament, the Summer or Winter Olympics, etc. At times the sporting event is aired on consecutive days, such as in the case of a golf tournament or the Olympics. However, other sporting events are aired on non-consecutive days, such as in the case of the World Series or NBA Finals. A fragmented program may also include a series of programs that are related and are broadcast on a given network for a specific period of time, such as “James Bond Week” that airs various James Bond movies during a week on a given network. Other examples of fragmented programs are programs that include regularly aired episodes or a plurality of programs that are designated as being related by having similar actors or themes. In view of the foregoing, it is to be understood that other types of fragmented programs exist, and the general principles disclosed herein can be used to record the fragments of such fragmented programs.

Therefore, at step 94 the system utilizes EPG data to identify each of the fragments that correspond to the selected fragmented program. Each fragment may be identified by a unique identifier assigned to the fragmented program coupled with a unique identifier for each fragment. Alternatively, title information may be used to identify the various fragments of the program.

Once all of the fragments of the selected program are identified, execution proceeds to decision block 96 for a determination as to whether or not the fragments are episodes. As mentioned above, one example of a fragmented program includes a television program (i.e. sitcom) that includes a series of episodes. As used herein, the term “episode” refers to a fragment of an ongoing, regularly repeating program. In an embodiment of the present invention, a television program that includes episodes is treated differently than other types of fragmented programs because the episodes may be re-runs that are undesirable for recording. In another embodiment, a viewer may want to record the re-runs, such as when the viewer desires a non-redundant copy of all of the episodes of a particular program, whether the episodes are first-run episodes or re-run episodes.

Therefore, in accordance with the illustrated embodiment, if a determination is made at decision block 96 that the fragments are not episodes, then execution proceeds to step 98, where the system automatically determines the start time for each fragment. The start time includes the channel, date and time the fragment is scheduled to air and is obtained from EPG data. The system is then automatically programmed at step 100 to record each of the fragments of the program.

Returning back to decision block 96, if it is determined that the fragments are episodes, then execution proceeds to step 102 where an episode is identified. Decision block 104 then determines whether the episode is a re-run. For purposes of this document, a “re-run” is an episode of a fragmented program that has already been broadcast at least once before. Furthermore, for purposes of this document a re-run may be a fragment of a fragmented program that has already been recorded. If the identified episode is not a re-run, the system is automatically programmed for the recording of the identified episode at step 106.

Once the system is automatically programmed to record the identified episode, execution proceeds to decision block 110 for a determination as to whether or not another episode of the fragmented program exists. If it is determined that another episode does not exist, execution returns back to start. However, if another episode exists, execution returns to step 102 for the identification of another episode at step 102 and for a determination at step 104 as to whether or not the identified episode is a re-run.

With reference to decision block 104, if it is determined that an identified episode is a re-run, execution proceeds to decision block 108 for a determination as to whether or not to record re-runs. A viewer may opt to have the system automatically record all of the episodes or to only record new episodes of the fragmented program. When the system records only new episodes, the system records each first-run episode of a particular fragmented program while automatically refraining from recording re-runs of episodes already recorded. Therefore, if a viewer does not desire to have the system record re-runs, execution proceeds to decision block 1 10 for a determination as to whether or not another episode exists. As above, if another episode does not exist, execution returns back to start. Alternatively, if another episode exists, execution returns back to step 102 for the identification of another episode.

Alternatively, if at decision block 108 it is determined that the user desires to have the system automatically record all of the episodes, including re-runs, then execution proceeds to step 106 where the system is automatically programmed for the recording of the identified episode. Execution then proceeds to decision block 110 for a determination as to whether or not there is another episode. If another episode does not exist, execution returns back to start. If another episode does exist, execution proceeds to step 102 for the identification of a subsequent episode. This process is continued until all of the episodes of the fragmented program have been identified and a determination is made as to which episodes of the fragmented program to automatically record. Of course, the process of identifying all fragments of the fragmented program may extend through a period of several days to as long as an entire television season, as the electronic program guide data is repeatedly updated.

Once the system has been automatically programmed in steps 100 and 106 to record all of the desired fragments of the program, each fragment is recorded as it airs. The EPG data informs the system as to any changes in the programming, such as when a fragment is preempted by another program, when one or more of the fragments are no longer scheduled to air, or when a fragment has been moved from one channel to another channel.

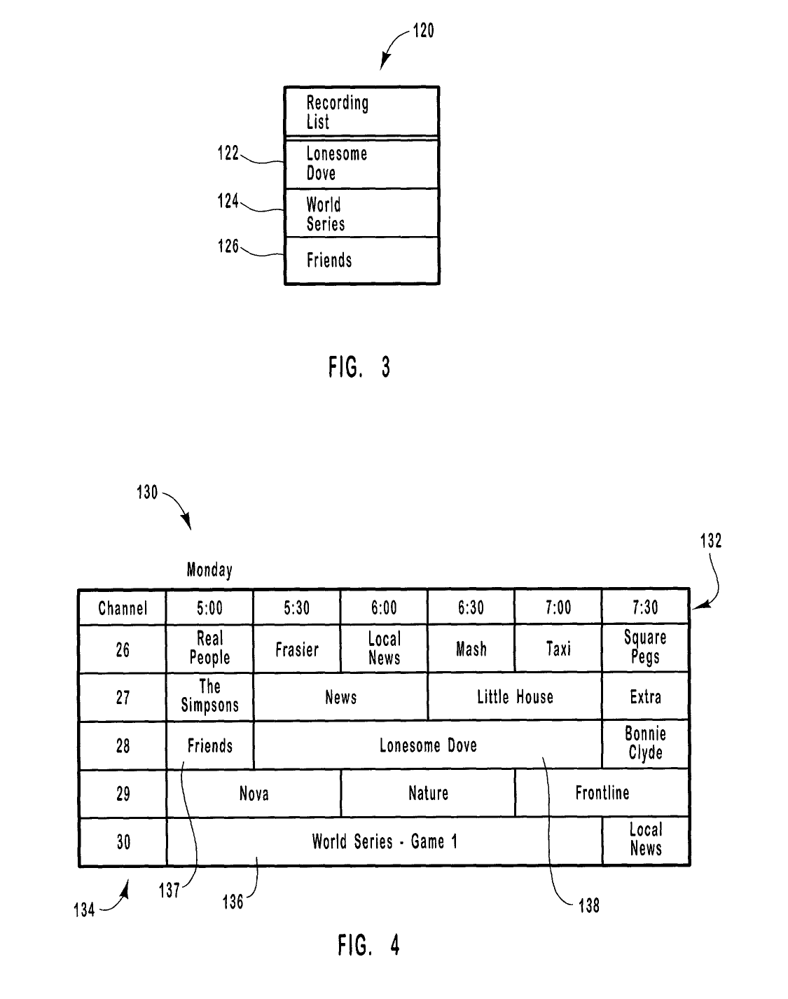

FIGS. 3-8 and the corresponding disclosure provide an example for recording various types of fragmented programs in accordance with the exemplary embodiment of FIG. 2. The types of fragmented programs identified in FIGS. 3-8 include a mini-series, an ongoing sporting event, and a television program having a series of episodes.

As indicated above, a viewer may select one or more fragmented programs to be automatically recording either by using a categories list or by directly providing the title of each program. Once one or more fragmented programs have been selected, the information is stored at the home entertainment system, such as on a mass storage device of a management system (i.e. management system 12 of FIG. 1).

Referring now to FIG. 3, a recording list is illustrated as recording list 120, which provides a list of fragmented programs that have been selected by a viewer for the system to automatically record. The fragmented programs included in the recording list 120 are a mini-series 122 entitled “Lonesome Dove”, a sporting event 124 entitled “World Series”, and a television program 126 entitled “Friends.”

FIGS. 4-8 provide exemplary portions of an EPG for five consecutive days, namely Monday through Friday, and are respectively labeled as EPG portions 130, 140, 150, 160, and 170. Each EPG portion includes the scheduled start time for the programming listed, such as start times 132 of FIG. 4, and the channel on which the programming is scheduled to air, such as channels 134 of FIG. 4.

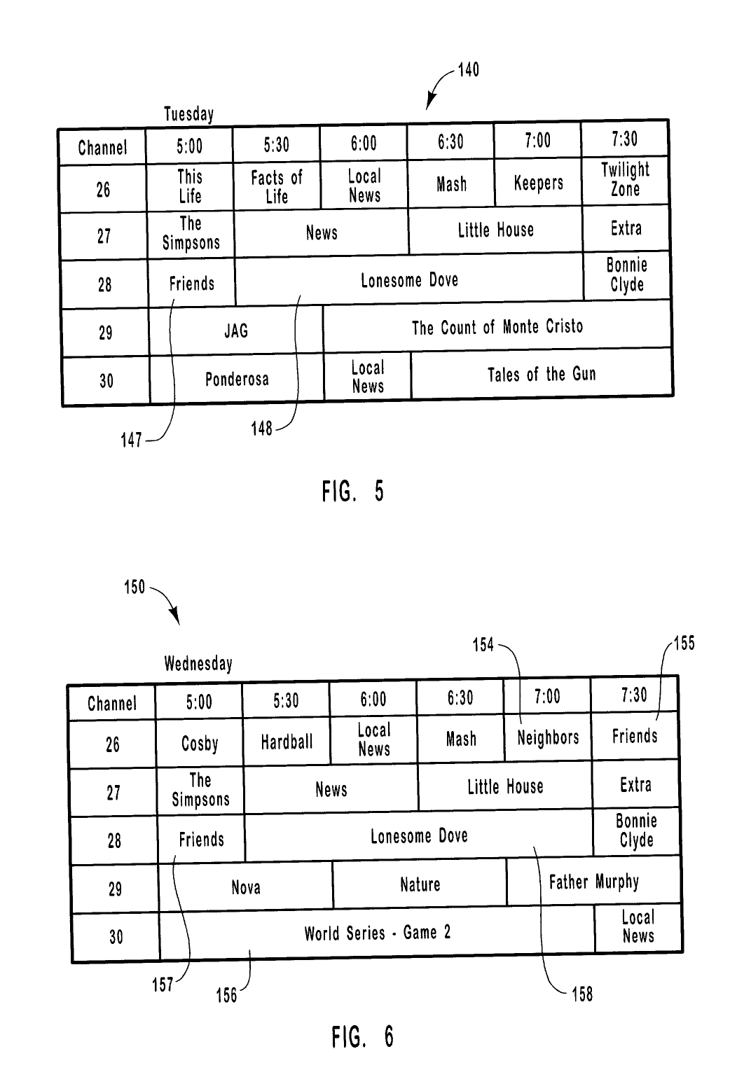

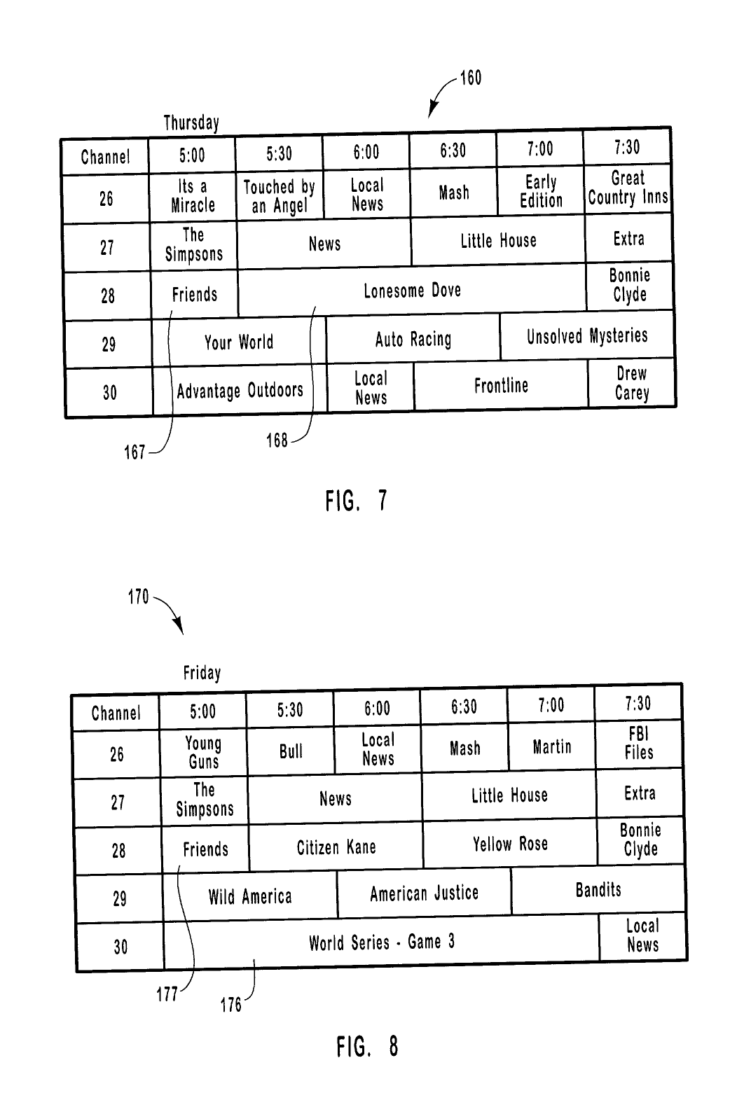

With reference to the fragmented program mini-series 122 of FIG. 3, a first fragment of mini-series 122 is scheduled to be aired on Monday from 5:30-7:30 (as indicated by mini-series fragment 138 of FIG. 4), a second fragment is scheduled to be aired on Tuesday from 5:30-7:30 (as indicated by mini-series fragment 148 of FIG. 5), a third fragment is scheduled to be aired on Wednesday from 5:30-7:30 (as indicated by mini-series fragment 158 of FIG. 6), and a fourth fragment is scheduled to be aired on Thursday from 5:30-7:30 (as indicated by mini-series fragment 168 of FIG. 7). After 7:30 on Thursday, the mini-series 122 is over since all of the fragments have aired.

Therefore, in accordance with the embodiment illustrated in FIG. 2, once mini-series 122 has been selected by a viewer and is on the recording list, as illustrated in FIG. 3, each of the fragments of mini-series 122 is identified. The fragments of mini-series 122 are then determined to not be episodes since mini-series 122 is only aired during a four-day period rather than over an entire season or a substantial portion of the season. The start time, including the date and channel, is then automatically determined from the EPG data. The start times for the fragments of mini-series 122 are Monday from 5:30-7:30, Tuesday from 5:30-7:30, Wednesday from 5:30-7:30, and Thursday from 5:30-7:30, which each fragment being aired on channel 28, as respectively illustrated in FIGS. 4-7. The system is then automatically programmed to record each of the fragments of mini-series 122 as each fragment airs.

With reference to the fragmented program sporting event 124 of FIG. 3, a first fragment of sporting event 124 is illustrated as sporting event fragment 136 in FIG. 4, which is scheduled to be aired on Monday from 5:00-7:30, a second fragment is illustrated as sporting event fragment 156 of FIG. 6, which is scheduled to be aired on Wednesday from 5:00-7:30, and a third fragment is illustrated as mini-series fragment 158 of FIG. 6, which is scheduled to be aired on Friday from 5:00-7:30. Since the MLB World Series is a best-of-seven tournament, other fragments of sporting event 124 would also be scheduled but are not illustrated. The total number of fragments can be from four to seven fragments depending on the number of games that are won by each team. Once a team has won four games of the World Series, sporting event 124 is over since all of the fragments have aired.

Therefore, in accordance with the embodiment illustrated in FIG. 2, once sporting event 124 has been selected by a viewer and is on the recording list, as illustrated in FIG. 3, each of the fragments is identified using EPG data. The fragments of sporting event 124 are then determined to not be episodes since sporting event 124 is only aired until one team wins four games of the tournament. The start time, including the date and channel, is then automatically determined from the EPG data and the system is automatically programmed to record each of the fragments of mini-series 122 as each fragment airs. As the EPG data is updated as to the number of fragments that will air for sporting event 124, the EPG data then updates the recording system so as to know the number of fragments to record.

With reference to the fragmented program television program 126 of FIG. 3, a first fragment of television program 126 is scheduled to be aired on Monday from 5:00-5:30 (as indicated by television program fragment 137 of FIG. 4), a second fragment is scheduled to be aired on Tuesday from 5:00-5:30 (as indicated by television program fragment 148 of FIG. 5), a third fragment is scheduled to be aired on Wednesday from 5:00-5:30 (as indicated by television program fragment 158 of FIG. 6), and a fourth fragment is scheduled to be aired on Wednesday from 7:00-7:30 (as indicated by television program fragment 155 of FIG. 6), a fifth fragment is scheduled to be aired on Thursday from 5:00-5:30 (as indicated by television program fragment 167 of FIG. 7), and a sixth fragment is scheduled to be aired on Friday from 5:00-5:30 (as indicated by television program fragment 177 of FIG. 8).

Therefore, in accordance with the embodiment illustrated in FIG. 2, once television program 126 has been selected by a viewer and is on the recording list, as illustrated in FIG. 3, each of the fragments of television program 126 is then identified. The fragments of television program 126 are determined to be episodes since fragments of television program 126 will air over an entire television season or a substantial portion thereof. Each episode is examined independently to differentiate first-run episodes from re-run episodes. The episodes illustrated in FIGS. 4-8 that air on channel 28, namely television program fragments 137, 147, 157, 167 and 177 are re-run episodes. However, the television program fragment 155, which is scheduled to be aired on channel 26 is a new episode.

Therefore, in accordance with the embodiment of FIG. 2, if a viewer desires to record only the new episodes of television program 126, the only illustrated fragment that is recorded is television program fragment 155 of FIG. 6 because it is the only fragment that is a first-run episode. All other new episodes throughout the season are also recorded by the system to provide a collection of all of the first-run episodes at the end of the season.

In a further embodiment, if one or more of the actors of television program fragment 155 of FIG. 6 are also scheduled to appear on television program fragment 154 and similar themes are to be portrayed to cause fragments 154 and 155 to be related, the system views fragments 154 and 155 as two fragments of the same fragmented program and both fragments 154 and 155 are recorded by the system.

In the example illustrated in FIGS. 4-8, the management system utilized as part of the recording system includes a plurality of tuners to allow for the recording of multiple programs that are aired at concurrent times (i.e. mini-series fragment 138 and sporting event fragment 136 of FIG. 4). Alternative embodiments allow for a single tuner to be used to record fragmented programs. In the event of a programming conflict where multiple fragmented programs are scheduled to be aired at concurrent times and thus cannot all be recorded with the use of a single tuner, the system may search the EPG data to determine whether one of the fragments will be aired later as a re-run on the same or a different channel to allow for all of the desired fragments to be recorded. Alternatively, a priority system may be established so that when a programming conflict occurs, the tuner is used to record the fragmented program with the highest priority.

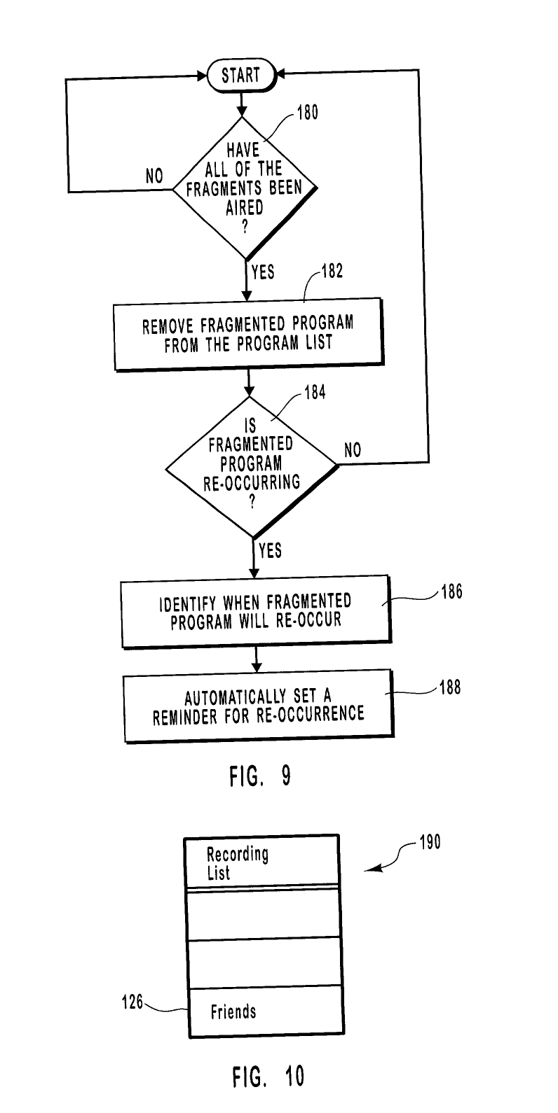

With reference to FIG. 9, a flowchart is illustrated to indicate what happens after a fragment of a program is recorded. Once all of the fragments have been aired, the fragmented program is removed from the recording list. However, if the fragmented program is repetitive, such as the Summer Olympics that airs every four years, the program is removed from the recording list and a reminder is set to remind the viewer prior to the subsequent airing of the fragmented program that the fragmented program will air.

Therefore, in FIG. 9, execution begins at decision block 180 where a determination is made as to whether or not all the fragments have been aired of the fragmented program. If all of the fragments have not been aired, execution returns back to start to allow for the airing of all of the fragments. When all of the fragments have been aired, execution proceeds to step 182 where the system removes the fragmented program from the program list.

The removal of a fragmented program from a recording list is illustrated in FIG. 10 by recording list 190, which is the state of recording list 120 of FIG. 4 after all of the fragments of mini-series 122 and sporting event 124 have been aired. In FIG. 10, only television program 126 remains on recording list 190.

Returning to FIG. 9, once the fragmented program is removed from the program list at step 182, a determination is made at decision block 184 as to whether or not the fragmented program that has been removed from the recording list is a reoccurring program. Examples of reoccurring fragmented programs include the MLB World Series, which airs annually, the Summer Olympics, which airs every four years, a television program that airs new episodes during each television season, etc.

Therefore, if the fragmented program that was removed from the recording list is not reoccurring, execution returns back to start. However, if the fragmented program is reoccurring, execution proceeds to step 186 for the identification of when the fragmented program will reoccur, which may be performed through the use of EPG data. Execution then proceeds to step 188 where the system automatically sets a reminder to be displayed to determine at a future time as to whether or not the system is to automatically record the reoccurrence of the fragmented program. For example, a reminder is set to inform the viewer prior to the next occurrence of the World Series that the World Series will soon air and inquires as to whether or not the viewer desires to record the various fragments of the subsequent airings of the World Series.

Thus, as indicated above, the present invention is related to systems and methods for identifying fragments of one or more programs that are related and are scheduled to be aired at discrete times, and for sequentially recording each of the fragments, without viewer intervention, so that a collection of the fragments is made available to the viewer. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In an entertainment system that includes a video recording apparatus, a method for automatically recording a fragmented program that includes a series of fragments that are temporally separated from each other and that have been designated as being related one to another in a way other than being episodes of an ongoing, repeating series, the method comprising the acts of:
receiving user input requesting the series of fragments to be recorded without requiring the user to separately identify each of the fragments in the series;
in response to said user input, examining electronic program guide data and identifying each of the fragments in the series; and
for each of the fragments, automatically determining a start time for the fragment and recording the fragment with the video recording apparatus when the fragment is aired.

2. A method as recited in claim 1, further comprising the acts of:
determining an end time for the fragment; and
deactuating the video recording apparatus when the fragment is completed.

3. A method as recited in claim 2, wherein the fragmented program is a mini-series.

4. A method as recited in claim 2, wherein the fragmented program is a sporting event.

5. A method as recited in claim 2, wherein the fragmented program is a group of television programs on a television network that are designated as being related.

6. A method as recited in claim 2, wherein said user input is received through the use of a categories menu.

7. A method as recited in claim 2, wherein said electronic program guide data includes an identifier for uniquely identifying the fragmented program.

8. A method as recited in claim 2, wherein said electronic program guide data includes an identifier that is common to the fragments and uniquely identifies the fragments from other programs.

9. A method as recited in claim 2, further including the act of repeatedly updating the system for each of the fragments as to said start time for the fragment through the use of current electronic program guide data.

10. A method as recited in claim 9, wherein said act of repeatedly updating further includes identifying when a scheduling change occurs for any of the fragments.

11. A method as recited in claim 2, further including the acts of:
determining whether the fragmented program is reoccurring; and
if the fragmented program is reoccurring, automatically setting a reminder to record a subsequent occurrence of the fragmented program.

12. In a system that includes a video recording apparatus, a method for automatically recording episodes of a television program so as to compile a non-repeating archive of the episodes during a period of time, the method comprising the acts of:
receiving user input specifying that the episodes of the television program are to be recorded; and
in response to said user input, and iteratively during the period of time, performing the following acts, such that a plurality of episodes of the television program are recorded without recording particular episodes more than once:
using electronic program guide data to identify an episode of the television program;
determining whether said episode has been previously recorded;
if it is determined that said episode has not been previously recorded, automatically recording said episode; and
if it is determined that said episode has been previously recorded, automatically refraining from recording said episode.

13. A method as recited in claim 12, wherein said electronic program guide data includes an identifier to uniquely identify said episode.

14. A method as recited in claim 12, wherein said act of using electronic program guide data further includes updating the system as to any programming change related to said episode.

15. A method as recited in claim 12, further performing the acts of:
determining whether said television program is reoccurring; and
if said television program is reoccurring, automatically setting a reminder to record a subsequent occurrence of said television program.

16. In a system that includes a video recording apparatus, a method for automatically recording first-run episodes of a television program so as to compile an archive of the first-run episodes during a period of time, the method comprising the acts of:
receiving user input specifying that the first-run episodes of the television program during the period of time are to be recorded;
using electronic program guide data to identify each of the first-run episodes of the television program that are scheduled to be aired during the period of time; and
for each of the first-run episodes, performing the acts of:
determining whether a first-run episode has been aired;
if it is determined that said first-run episode has not been aired, automatically recording said first-run episode; and
if it is determined that said first-run episode has been previously aired, performing the acts of:
determining whether said first-run episode is scheduled to be aired at a future time; and
if said first-run episode is scheduled to be aired at a future time, automatically recording said first-run episode at said future time.

17. A method as recited in claim 16, wherein upon determining that said first-run episode has been previously aired, further performing the act of if said first-run episode is not schedule to be aired at a future time, informing a viewer that said first-run episode has already aired and is not scheduled to be aired at a future time.

18. A method as recited in claim 16, wherein said electronic program guide data includes an identifier to uniquely identify each of the first-run episodes.

19. A method as recited in claim 16, wherein said act of using electronic program guide data further includes updating the system as to a programming change related to the first-run episodes.

20. A method as recited in claim 19, wherein if said programming change relates to a new time of airing one of the first-run episodes, which was originally determined to have already aired and was not scheduled to air at a future time, further performing the act of automatically recording said one of the first-run episodes at said new time.

21. A recording system for recording video data corresponding to a fragmented program, the recording system comprising:
a signal receiver for receiving a signal that carries programming, wherein said programming includes a fragmented program, which includes a plurality of fragments that are scheduled to be aired over a series of days;
a user input interface coupled to said signal input, wherein said user input interface receives user input requesting said plurality of fragments to be recorded without requiring a user to separately identify each fragment of said fragmented program, and wherein upon receipt of said user input electronic program guide data is used to identify each fragment of said fragmented program; and
a signal recorder coupled to said signal input for sequentially recording onto a storage medium each of said plurality of fragments.

22. A recording system as recited in claim 21, wherein said electronic program guide data includes an identifier that is common to said fragments and uniquely identifies said fragments from the programs.

23. A recording system as recited in claim 21, wherein said electronic program guide data includes a common title to identify each said fragment.

24. A recording system as recited in claim 21, wherein said user input interface includes a categories list to enable a user to select said fragmented program for recording.

25. A recording system as recited in claim 21, further including a recording list preserved on a storage device coupled to said user input interface, wherein said recording list itemizes one or more fragmented programs that correspond to said plurality of fragments to be recorded.

26. A computer program product for implementing within a home entertainment system a method for recording a fragmented program so as to provide a viewer a collection of all of the fragments of the fragmented program, the computer program product comprising:
a computer readable medium for providing computer program code means utilized to implement the method, wherein the computer program code means is comprised of executable code for implementing the acts of:
receiving user input requesting a series of fragments of the fragmented program to be automatically recorded;
examining electronic program guide data to identify when each of said series of fragments is scheduled to air; and
sequentially recording said each of said series of fragments to provide the user with a collection of said series of fragments.

27. A computer program product as recited in claim 26, wherein said user input is received through the use of a menu system that identifies one or more fragmented programs that are scheduled to air during a period of time, and wherein the fragmented program is one of said one or more fragmented programs.

28. A computer program product as recited in claim 26, wherein said act of examining electronic program guide data further includes identifying any scheduling change in the airing of said series of fragments.

29. A computer program product as recited in claim 26, wherein if said user input includes a request to only record fragments of the fragmented program that are first-run episodes, said act of examining further includes determining whether any of said series of fragments is a first-run episode, and wherein said act of sequentially recording further includes recording only fragments that are first-run episodes.

30. A computer program product as recited in claim 26, further including the acts of:
determining whether the fragmented program is reoccurring; and
if the fragmented program is reoccurring, automatically setting a reminder to record a subsequent occurrence of the fragmented program.
